(19) United States
(12) Patent Application Publication
(10) Pub. No.: US 2026/0340570 A1
(43) Pub. Date: Oct. 29, 2026

(54) Logistics distribution system based on intelligent alignment of drones and aprons and method therefor

(71) Applicant: Hangzhou City University, Hangzhou City (CN)

(72) Inventors: Fang Wang, Hangzhou City (CN); Jie Liu, Hangzhou City (CN); Wenqiang Liu, Hangzhou City (CN); Lei Wang, Hangzhou City (CN); Kelin Jiang, Hangzhou City (CN); Yishi Wang, Hangzhou City (CN); Haifeng Wang, Hangzhou City (CN)

(73) Assignee: Hangzhou City University, Hangzhou City (CN)

(21) Appl. No.: 19/238,768

(22) Filed: Jun. 16, 2025

(30) Foreign Application Priority Data
Apr. 27, 2025 (CN) 2025105386482

(51) Int. Cl. G06Q 10/0836; B64U 70/97; B64U 101/64

(52) U.S. Cl. CPC G06Q 10/0836; B64U 70/97; B64U 2101/64

(57) ABSTRACT

A logistics distribution system based on intelligent alignment of drones and aprons, and a method therefor. In the logistics distribution system, an open-top apron is arranged on a top portion of a box body, an internal functional area is arranged inside the box body, and an external rider pickup area is arranged on one side wall of the box body. The present invention combines an infrared beacon and RTK base station positioning system to achieve precise landing of logistics boxes into the box body through a logistics box receiving hole. After the logistics boxes are taken down by sort personnel, the logistics boxes are placed on a sorting table and sorted to corresponding logistics grids according to destinations. Takeaway riders scan codes in front of a code scanning and pickup device according to order information, and pick up and deliver goods after the indicator lights come on.

### CROSS-REFERENCE

This application claims the benefit of priority from China Patent Application No. CN2025105386482 filed on Apr. 27 2025, the contents of which are hereby incorporated by reference in their entirety.

### TECHNICAL FIELD

The present invention belongs to the technical field of intelligent logistics, and in particular relates to a logistics distribution system based on intelligent alignment of drones and aprons and a method therefor.

### BACKGROUND TECHNOLOGY

With the rapid development of drone technology, drone logistics and delivery has become a highly-watched development direction in the modern logistics industry. With its advantages of high efficiency, environmental protection, and low cost, drone logistics and delivery has shown great potential in the fields of urban instant delivery and emergency material delivery. However, drone logistics and delivery does not exist in isolation. Many cities in China are building logistics transfer stations to support drone logistics terminal delivery. Logistics transfer stations undertake core functions such as battery replacement, cargo transfer, and data synchronization, and have become an indispensable part of the drone logistics network.

At present, the existing logistics transfer stations lack windproof, rainproof and safety buffer designs for drone operations, which poses a safety hazard. In addition, the traditional grid layout is not compatible with drone landing and rider manual lines, and the space utilization rate is low. At the same time, there are also problems such as the separation of drone delivery and ground sorting processes and low distribution efficiency.

### SUMMARY OF THE INVENTION

In view of this, in order to solve the problems of poor versatility, complex structure, high testing cost and large testing space occupied by traditional testing systems, the present invention provides a logistics distribution system based on intelligent alignment of drones and aprons, comprising a box body, an open-top apron, an internal functional area and an external rider pickup area, wherein the open-top apron is arranged on a top portion of the box body, the internal functional area is arranged inside the box body, and the external rider pickup area is arranged on one side wall of the box body, wherein,
the box body comprises a main structure and a box door;
the open-top apron comprises a drone apron, a logistics box receiving hole, infrared beacons, an RTK base station and a surveillance camera, wherein the logistics box receiving hole is arranged at a central position of the drone apron; the infrared beacons are arranged around the logistics box receiving hole, a quantity of the infrared beacons is at least 4; the RTK base station is arranged at one corner of the drone apron; and the surveillance camera is arranged at another corner of the drone apron;
the internal functional area comprises a charging and swapping area, a personnel rest area, a spare parts area, a material sorting area and a command and operation area; and
the external rider pickup area comprises logistics grids, a code scanning and pickup device and indicator lights.

Preferably, the main structure of the box body comprises a steel structure, and inner walls of the box body are provided with heat insulation layers.

Preferably, edges of the logistics box receiving hole are provided with a buffer device of elastic silica gel and/or air pressure damping.

Preferably, the infrared beacons comprise sets of several infrared light sources, and each set corresponds to a unique position information code.

Preferably, the RTK base station provides real-time position information and heading information for drones.

Preferably, the charging and swapping area comprises drone charging and swapping cabinets and battery vehicle charging and swapping cabinets, which integrate multi-protocol interfaces.

Preferably, the material sorting area comprises a sorting table and logistics boxes, the sorting table is arranged directly below the logistics box receiving hole, and the logistics boxes are placed above the sorting table.

Preferably, the command and operation area comprises an operation console, a monitoring screen and an operation panel.

Preferably, a method used for the logistics distribution system based on intelligent alignment of drones and aprons comprises following steps of:
S1—drone positioning, wherein a drone mounted with a logistics box flies to an area of the open-top apron, and through the infrared beacons and the RTK base station, the drone positions to fly to an area above the logistics box receiving hole;
S2—logistics box buffer landing, wherein a size of the logistics box receiving hole is smaller than a length of drone tripods and larger than a length of a logistics box, the drone lands on the drone apron, and the logistics box buffers and lands to the material sorting area inside the box body through the logistics box receiving hole;
S3—manual sorting, wherein after the logistics box is taken down by sorting personnel, the logistics box is placed on the sorting table and sorted to a corresponding logistics grid according to destination; and
S4—a takeaway rider scans a code to pick up goods, wherein a takeaway rider scans a code in front of the scanning and picking device according to order information, and after an indicator light is on, the takeaway rider goes to the corresponding logistics grid to pick up the goods for delivery.

Preferably, the RTK base station is set so that a drone flies to the drone apron according to a route, when the drone lands at a preset height, infrared sensors carried by the drone identifies the infrared beacons placed around the logistics box receiving hole, and a built-in algorithm is used to vertically align the logistics box carried by the drone with a geometric center of the logistics box receiving hole.

The present invention comprises at least following beneficial effects:
1. Dynamic path planning: through the vertical alignment design of the logistics box receiving hole and sorting table (error≤3 cm), seamless transmission of drone→logistics box receiving hole→sorting table→grid is realized;
2. Safety redundancy system: buffer devices arranged at edges of the logistics box receiving hole (elastic silicone and air pressure damping) can withstand the impact of a 30 kg logistics box at a speed of 3 m/s;
3. Multi-protocol compatibility: charging cabinets support mainstream drone/electric vehicle battery interfaces;
4. Infrared and RTK positioning design: by laying out an RTK base station on the upper part of the box body, it is ensured that it can accurately fly to the drone apron according to the route. In order to further reduce the RTK positioning error, when a drone lands at a certain height, the infrared sensors carried by the drone identifies the infrared beacons laid out on the periphery of the hole, and through the built-in algorithm, it ensures that the center of the drone-logistics box-hole-sorting platform is vertically aligned to achieve precise landing;
5. Human-machine separation safety design: a logistics box receiving hole is set on the upper part of the box body, and the size of the logistics box receiving hole is customized based on the logistics box and the drone tripods, combined with infrared and RTK The positioning system enables the drone to land accurately on the receiving hole of the logistics box. At the same time, the logistics box can fall into the hole, realizing the separation of man and machine and ensuring the safety of drone logistics delivery.

### BRIEF DESCRIPTION OF THE DRAWINGS

FIG. 1 is a schematic diagram of a cross-sectional structure of a logistics distribution system based on intelligent alignment of drones and aprons according to an embodiment of the present invention.

FIG. 2 is a schematic diagram of a side view structure of a logistics distribution system based on intelligent alignment of drones and aprons according to an embodiment of the present invention.

FIG. 3 is a schematic diagram of a top view structure of a logistics distribution system based on intelligent alignment of drones and aprons according to an embodiment of the present invention.

FIG. 4 is a flow chart of a method for the logistics distribution based on intelligent alignment of drones and aprons according to an embodiment of the present invention.

### SPECIFIC EMBODIMENTS

The preferred embodiments of the present invention will be described in detail below with reference to the accompanying drawings.

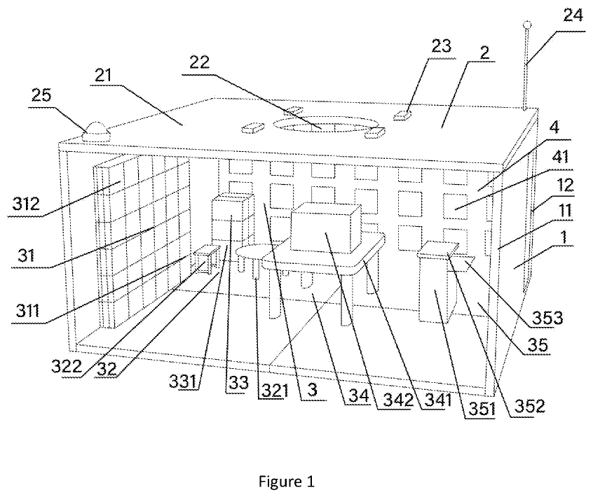

Please refer to FIGS. 1-3, a logistics distribution system based on intelligent alignment of drones and aprons, comprises a box body 1, wherein the box body 1 comprises a main structure 11 and a box door 12; a top portion of the box body 1 is provided with an open-top apron 2, the open-top apron 2 comprises a drone apron 21, on the open-top apron 21 is paved with anti-skid and wear-resistant materials, a logistics box receiving hole 22 is arranged at a center portion, infrared beacons 23 surround the logistics box receiving hole 22, edges of the logistics box receiving hole 22 are provided with a buffer device, corners of the drone apron 21 are equipped with an RTK base station 24 and a surveillance camera 25; inside the box body 1 is an internal functional area 3 which comprises a charging and swapping area 31, a personnel rest area 32, a spare parts area 33, a material sorting area 34 and a command and operation area 35, wherein the charging and swapping area 31 is equipped with drone charging and swapping cabinets 311, and battery car charging and swapping cabinets 312, the personnel rest area 32 is equipped with a table 321 and a chair 322, the spare parts area 33 is equipped with spare parts cabinets 331, and the material sorting area 34 is set in a center portion of the box body 1, including a sorting table 341 and a logistics box 342, and the command and operation area 35 is equipped with an operation table 351, a monitoring screen 352 and an operation panel 353. Outside the box body is an external rider pickup area 4, which has different numbers of logistics grids 41, and is equipped with a code scanning and pickup device 42 and indicator lights 43.

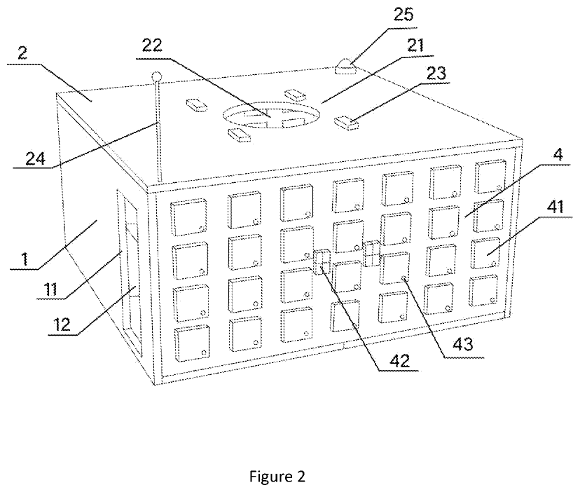

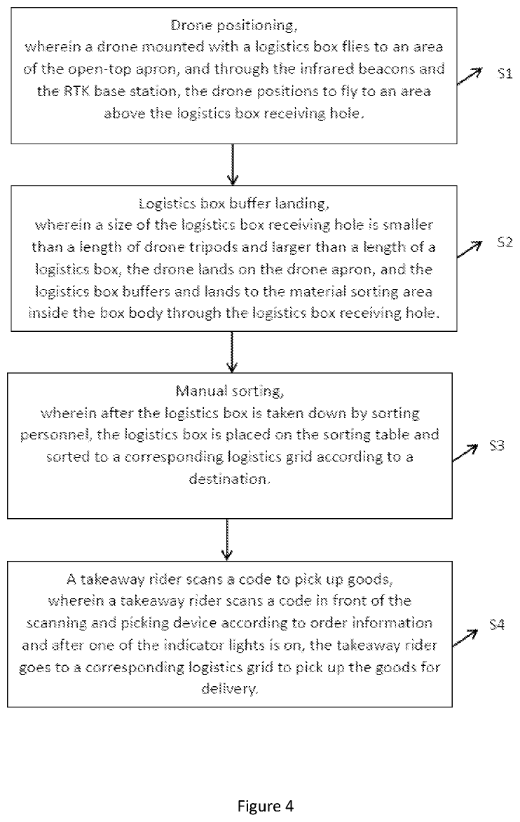

Please refer to FIG. 4, a distribution method of the present invention comprises following steps of:
S1—a drone carrying the logistics box 342 flies to the logistics box receiving hole 22 according to a designated route and starts to land, the drone accurately lands on the logistics box receiving hole 22; through the infrared beacons 23 and the RTK base station 24, the drone lands accurately on the logistics box receiving hole 22. S2—through the precise design of the size of the logistics box receiving hole 22, the drone lands on the drone apron 21, and the logistics box 342 is buffered and landed in the internal functional area 3 of the box body 1 through the logistics box receiving hole 22. S3—after the logistics box 342 is taken down by a sorting staff, the logistics box 342 is placed on the sorting table 341 and sorted to a corresponding logistics grid 41 according to a destination. S4—the takeaway rider scans the code in front of the scanning and picking device 42 according to the order information, and within 5 seconds after one of the indicator light 43 lights up, he goes to the corresponding logistics grid 41 to pick up the goods for delivery. The structural position refers to FIG. 2.

The drone relies on the infrared and RTK positioning system for precise landing. The RTK base station 24 and GPS satellite positioning information are used to calculate the GPS positioning error and send it to the drone, thereby correcting the landing position information of the drone and obtaining navigation information with centimeter-level accuracy. To further reduce the landing positioning error, when the drone lands 3-5 meters away from the drone apron, the infrared camera on the drone receives signals of the infrared beacons 23, and uses the built-in algorithm to correct the position, obtain the spatial position relationship between the logistics box receiving hole 22 and the infrared beacons 23, and calculate the actual position coordinates of the logistics box receiving hole 22, so that the geometric center of the drone-logistics box 342-logistics box receiving hole 22-sorting table 341 is vertically aligned to achieve precise landing.

The surface of the drone apron 21 is paved with anti-skid and wear-resistant materials to prevent the drone from skidding and causing wear to the box body 1 during take-off and landing. The surveillance camera 25 is installed at a corner of the drone apron 21 to record the take-off and landing process of the drone, so that emergency measures can be taken in time and accident information can be traced when an abnormality occurs during the take-off and landing process of the drone.

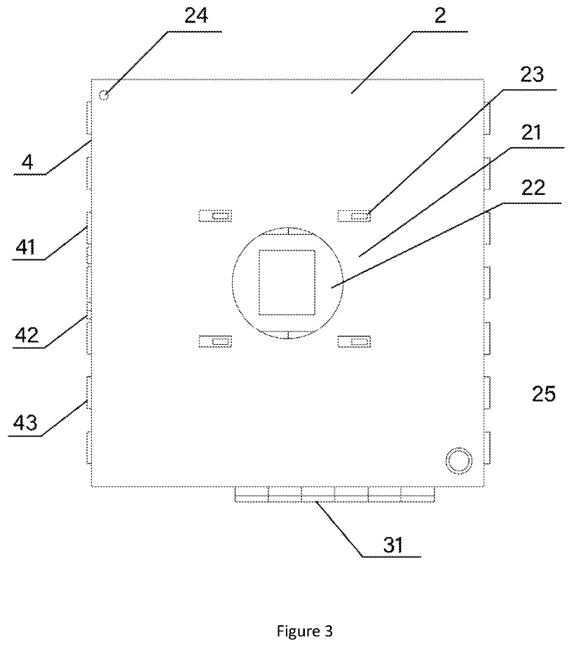

Please refer to FIG. 3, the design principle of the size of the logistics box receiving hole 22 is to ensure that the drone can land accurately on the logistics box receiving hole 22, and the logistics box 342 can fall into the logistics box receiving hole 22. Therefore, the size of the logistics box receiving hole 22 should be smaller than the length of the drone tripod and larger than the length of the logistics box 342. In order to avoid the collision between the logistics box 342 and the edge of the logistics box receiving hole 22 and cause damage to the materials, the logistics box receiving hole 22 adopts a redundant safety design. The edges of the logistics box receiving hole 22 are provided with a buffer device of elastic silicone and air pressure damping, which can withstand the impact of a 30 kg logistics box at a speed of 3 m/s to ensure the integrity of the materials and the safety of the box.

The operator, in front of the operating table 351, uses the operating panel 353 to dispatch and control the flight path and flight attitude of the drone according to the drone take-off and landing status and flight position, flight altitude, speed, battery power and other information displayed on the monitoring screen 352. After the drone lands, if the monitoring screen 352 shows that the drone battery power is insufficient to support the next voyage, the operator can take out a fully charged battery from the drone charging and swapping cabinet 311 for replacement to ensure the delivery efficiency of the drone. If there is an abnormality during the flight of the drone, the operator can take out the onboard components, multimeter, electric melting iron, propeller blades, power tools, etc. from the spare parts cabinets 331 to inspect and replace the drone parts to ensure flight safety. After working for a long time or during non-logistics peak hours, the operator can take a short break in the personnel rest area 32 to ensure work efficiency.

When a takeaway rider is picking up the goods, if the battery of the electric vehicle is low on power, the charging and swapping area 31 provides a multi-port charging module to provide the takeaway rider with a fast charging service. At the same time, the battery charging and swapping cabinet 312 supports the fast replacement of the battery of the electric vehicle to ensure the delivery efficiency of the takeaway rider.

The above are only some preferred embodiments of the present invention and are not intended to limit the present invention. Any modifications, equivalent substitutions and improvements made within the spirit and principles of the present invention should be included in the protection scope of the present invention.

1. A logistics distribution system based on intelligent alignment of drones and aprons, comprising a box body, an open-top apron, an internal functional area and an external rider pickup area, wherein the open-top apron is arranged on a top portion of the box body, the internal functional area is arranged inside the box body, and the external rider pickup area is arranged on one side wall of the box body, wherein,
the box body comprises a main structure and a box door;
the open-top apron comprises a drone apron, a logistics box receiving hole, infrared beacons, an RTK base station and a surveillance camera, wherein the logistics box receiving hole is arranged at a central position of the drone apron; the infrared beacons are arranged around the logistics box receiving hole, and a quantity of the infrared beacons is at least 4; the RTK base station is arranged at one corner of the drone apron; and the surveillance camera is arranged at another corner of the drone apron;
the internal functional area comprises a charging and swapping area, a personnel rest area, a spare parts area, a material sorting area and a command and operation area; and
the external rider pickup area comprises logistics grids, a code scanning and pickup device and indicator lights.

2. The logistics distribution system based on intelligent alignment of drones and aprons according to claim 1, wherein the main structure of the box body comprises a steel structure, and inner walls of the box body are provided with heat insulation layers.

3. The logistics distribution system based on intelligent alignment of drones and aprons according to claim 1, wherein edges of the logistics box receiving hole are provided with a buffer device of elastic silica gel and/or air pressure damping.

4. The logistics distribution system based on intelligent alignment of drones and aprons according to claim 1, wherein the infrared beacons comprise sets of several infrared light sources, and each set corresponds to a unique position information code.

5. The logistics distribution system based on intelligent alignment of drones and aprons according to claim 1, wherein the RTK base station provides real-time position information and heading information for drones.

6. The logistics distribution system based on intelligent alignment of drones and aprons according to claim 1, wherein the charging and swapping area comprises drone charging and swapping cabinets and battery vehicle charging and swapping cabinets, which integrate multi-protocol interfaces.

7. The logistics distribution system based on intelligent alignment of drones and aprons according to claim 1, wherein the material sorting area comprises a sorting table and logistics boxes, the sorting table is arranged directly below the logistics box receiving hole, and the logistics boxes are placed above the sorting table.

8. The logistics distribution system based on intelligent alignment of drones and aprons according to claim 1, wherein the command and operation area comprises an operation console, a monitoring screen and an operation panel.

9. A method used for the logistics distribution system based on intelligent alignment of drones and aprons according to claim 1, comprising following steps of:
S1—drone positioning, wherein a drone mounted with a logistics box flies to an area of the open-top apron, and through the infrared beacons and the RTK base station, the drone positions to fly to an area above the logistics box receiving hole;
S2—logistics box buffer landing, wherein a size of the logistics box receiving hole is smaller than a length of drone tripods and larger than a length of a logistics box, the drone lands on the drone apron, and the logistics box buffers and lands to the material sorting area inside the box body through the logistics box receiving hole;
S3—manual sorting, wherein after the logistics box is taken down by sorting personnel, the logistics box is placed on the sorting table and sorted to a corresponding logistics grid according to a destination; and
S4—a takeaway rider scans a code to pick up goods, wherein a takeaway rider scans a code in front of the scanning and picking device according to order information and after one of the indicator lights is on, the takeaway rider goes to a corresponding logistics grid to pick up the goods for delivery.

10. The method used for the logistics distribution system based on intelligent alignment of drones and aprons according to claim 9, wherein the RTK base station is set so that a drone flies to the drone apron according to a route, when the drone lands at a preset height, infrared sensors carried by the drone identifies the infrared beacons placed around the logistics box receiving hole, and a built-in algorithm is used to vertically align the logistics box carried by the drone with a geometric center of the logistics box receiving hole.
